(19) United States
(12) Patent Application Publication
(10) Pub. No.: US 2014/0166730 A1
(43) Pub. Date: Jun. 19, 2014

(54) ULTRASONIC SOLDERING PROCESS FOR ELECTRICALLY POWERED IGUs

(71) Applicant: SAGE Electrochromics, Inc., Faribault, MN (US)

(72) Inventors: Cliff Taylor, Northfield, MN (US); Reul Bernhard, Herzogenrath (DE); Neil L. Sbar, Northfield, MN (US)

(73) Assignee: SAGE ELECTROCHROMICS, INC., Faribault, MN (US)

(21) Appl. No.: 14/104,265

(22) Filed: Dec. 12, 2013

Related U.S. Application Data
(60) Provisional application No. 61/736,801, filed on Dec. 13, 2012.
(60) Provisional application No. 61/764,780, filed on Feb. 14, 2013.

(51) Int. Cl. B23K 20/10; B23K 37/04

(52) U.S. Cl. CPC B23K 20/10; B23K 37/04
USPC 228/110.1; 228/1.1; 228/49.5; 228/44.7

(57) ABSTRACT

The present invention relates to an ultrasonic soldering tool for soldering wires to a solder tab of an electrochromic device located between the layers of an insulated glass unit. The soldering tool includes an ergonomically designed handle and soldering tip head to increase operator comfort during use while also providing features to ensure that the surface of the insulated glass unit is not contacted by the soldering tip. One embodiment of the invention provides an automatic feed soldering tool which may have a soldering tip with a trough to create an ideal solder joint. The invention also includes a clamp for securing a wire to a substrate in a correct position while serving as a guide for the soldering tool to provide further protection from errant contact between the soldering tip and the insulated glass unit. The invention also includes a method of creating an ideal solder joint.

### CROSS REFERENCE TO RELATED APPLICATIONS

The present application claims the benefit of the filing date of U.S. Provisional Application No. 61/736,801, filed Dec. 13, 2012, and U.S. Provisional Application No. 61/764,780, filed Feb. 14, 2013, the disclosures of which are hereby incorporated herein by reference.

### BACKGROUND OF THE INVENTION

A thin film device e.g. an electrochromic device, is deposited on a glass substrate which is incorporated into an insulating glass unit (IGU). This patent application addresses the process, equipment, and materials for soldering electrical interconnections to bus bars on the device.

Electrochromic glazings include electrochromic materials that are known to change their optical properties, such as coloration, in response to the application of an electrical potential, thereby making the device more or less transparent or more or less reflective. Typical prior art electrochromic devices include a counter electrode layer, an electrochromic material layer which is deposited substantially parallel to the counter electrode layer, and an ionically conductive layer separating the counter electrode layer from the electrochromic layer respectively. In addition, two transparent conductive layers are substantially parallel to and in contact with the counter electrode layer and the electrochromic layer.

Materials for making the counter electrode layer, the electrochromic material layer, the ionically conductive layer and the conductive layers are known and described, for example, in United States Patent Publication No. 2008/0169185, incorporated by reference herein, and desirably are substantially transparent oxides or nitrides. When an electrical potential is applied across the layered structure of the electrochromic device, such as by connecting the respective conductive layers to a low voltage electrical source, ions, such as Li+ ions stored in the counter electrode layer, flow from the counter electrode layer, through the ion conductor layer and to the electrochromic layer.

In addition, electrons flow from the counter electrode layer, around an external circuit including a low voltage electrical source, to the electrochromic layer so as to maintain charge neutrality in the counter electrode layer and the electrochromic layer. The transfer of ions and electrons to the electrochromic layer causes the optical characteristics of the electrochromic layer, and optionally the counter electrode layer in a complementary EC device, to change, thereby changing the coloration and, thus, the transparency of the electrochromic device.

As used herein, the term “insulated glass unit” (IGU) means two or more layers of glass separated by a spacer (metal, plastic, foam, resin based) along the edge and sealed to create a dead air space, “insulated space” (or other gas, e.g. argon, nitrogen, krypton) between the layers. The IGU comprises an interior glass panel and an EC device, described further herein.

Electrical connection to the electronic device is achieved by thick film silver (Ag) solder tabs external to the adhesively bonded spacer. The solder tabs are electrically connected to thick film Ag bus bars which contact conductive device layers inside the IGU. Wires delivering electrical power are soldered to the bus bars which terminate in solder tabs exterior to the spacer. The space between the two glass substrates where the attachment to the solder tab is made is narrow and may be less than about 6 mm high.

### SUMMARY OF THE INVENTION

The invention relates to an ultrasonic soldering tool and method of soldering. The soldering tool according to one aspect of the disclosure has a handle with an ultrasonic soldering element secured to it by at least one rib. The ultrasonic soldering element can be adapted to receive a soldering tip that may operate between parallel substrates of an insulated glass unit, preferably through incorporation of a trough in the soldering tip head.

The rib of the soldering tool according to one aspect of the disclosure can be adapted to incorporate additional interconnected elements. One of the additional interconnected elements may be a bubble level which can be mounted substantially parallel to the soldering tip head to accurately reflect the angular pitch of the head during operation of the soldering tool.

The soldering tool according to one aspect of the disclosure may use a trigger to directly activate power to the tool. The trigger could also send a signal to digital timer circuitry to activate power to the tool. The digital timer circuitry desirably includes a switch to activate power to the ultrasonic soldering element, an indicator LED on the soldering tool, and an audible signal generator which may indicate when the soldering cycle is complete.

The soldering tool according to one aspect of the disclosure is an automatic feed soldering tool that can supply solder to the desired solder joint location. The automatic tool can have interconnected elements mounted to the at least one rib including a solder roll, drive rollers, a gear motor, and a solder feed tube.

The automatic soldering tool according to one aspect of the disclosure may have the solder roll mounted to the at least one rib, the drive rollers mounted to the solder roll, and the solder feed tube mounted to the drive rollers. The gear motor may be mounted to and adapted to rotate the drive rollers. The drive rollers may then transfer solder from the solder roll through the solder feed tube. The solder may emerge from the feed tube at the soldering tip head.

The gear motor according to one aspect of the disclosure may supply a fixed volume of solder to the soldering head. In other embodiments, the gear motor may be adjustable to modify the volume of solder supplied.

The soldering tool according to one aspect of the disclosure may have a soldering tip head with a trough. A solder feed port may extend from an exterior surface of the tip into the trough. The feed port may be adapted to transport solder from the feed tube into the trough. Another aspect of the disclosure may use a solder well adapted to receive and melt the solder from the feed tube before it enters the solder feed port.

Another aspect of the disclosure is a soldering tip, which can be an elongated member having a head with a trough. The trough may be adapted to surround a wire during soldering and can be oriented substantially horizontally to the soldering element. A solder feed port may extend from an exterior surface of the soldering tip into the trough and is preferably sized to transport solder via capillary action. According to one aspect of the disclosure, the trough can have a parabolic profile. The soldering tip may also have a solder well to melt solder before it enters the solder feed port.

The method of creating a solder joint according to one aspect of the disclosure desirably uses a clamp. The clamp may have a housing, an upper jaw, a lower jaw, a sled, and a spring. The housing may have a chamber to receive the sled which may be free to move in at least one dimension within the chamber. The spring can also be located within the chamber. The upper jaw can be connected to the housing, and the lower jaw can be connected to the sled. The spring may exert a force against the sled and housing to maintain the upper jaw and lower jaw in close proximity to each other.

According to one aspect of the clamp, there can be a stub extending from the housing and a beam extending from the sled. The beam may be free to move along a path defined by a slot in the housing. The beam and stub may extend in similar directions so an operator can adjust the position of the beam relative to the stub with one hand, thereby changing the proximity of the upper jaw and lower jaw. Another aspect of the disclosure is the lower jaw may have a protective material attached to it.

The method of ultrasonically soldering a wire to a solder tab according to one aspect of the disclosure desirably includes the steps of preparing a wire to be soldered, cleaning the solder tab, positioning the wire on the solder tab; fixing the wire in position with a clamp; positioning a soldering tool to solder the wire; ultrasonically soldering the wire to the solder tab which can result in a solder joint formed in a space between the layers of an insulated glazing unit.

The method of ultrasonically soldering a wire in another aspect may include forming an ideal solder joint by delivering a precise volume of solder to the solder joint, thereby creating a solder joint having a desired pull strength using minimal solder. In some embodiments, solder may be pre-applied to the wire before soldering to help ensure that a precise volume of solder is used. In other embodiments, solder may be delivered during the soldering process through use of an automatic feed soldering tool.

The quality of the solder joint can be controlled according to one aspect of the disclosure by monitoring the volume of solder supplied to the joint and the duration of contact between the soldering tool and the wire.

### BRIEF DESCRIPTION OF THE DRAWINGS

A more complete appreciation of the subject matter of the present invention and the various adavantages thereof can be realized by reference to the following detailed description, in which reference is made to the accompanying drawings:

FIG. 1 is an illustrative embodiment of a soldering tool of the present invention.

FIG. 2 is a top view of the soldering tool of FIG. 1.

FIG. 3 is a sectional view of the soldering tool of FIG. 1.

FIG. 4A shows one embodiment of a soldering tip according to the present invention in various stages of manufacture.

FIG. 4B is a perspective view of the soldering tip of FIG. 4A.

FIG. 5 is an enlarged view showing a soldering tip head according to one embodiment of the current invention.

FIG. 6 is an isolated view of the soldering tip in operation.

FIG. 7 shows a soldering tool, clamp, wire, and IGU in use according to one embodiment of the current invention.

FIG. 8 shows a clamp according to one embodiment of the present invention.

FIG. 9 shows an alternative embodiment of a clamp according to the present invention.

FIG. 10 is an isolated view showing a clamp securing a wire to an IGU.

FIG. 11 is an enlarged view showing the soldering tip, wire, and clamp of FIG. 7.

FIG. 12 is an enlarged view of an ideal solder joint.

FIG. 12A is a sectional view of the ideal solder joint of FIG. 12.

FIG. 13 is a side and front view of a wire with pre-formed solder attached.

FIG. 14 is a flow chart depicting the process of soldering a wire in accordance with one embodiment of the current invention.

### DETAILED DESCRIPTION

Although the invention disclosed in this application has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended exemplary claims.

Overall Process Flow

Thin films and other structures are deposited on the glass device substrate by methods known to those skilled in the art as described in, for example, U.S. Pat. Nos. 5,321,544; 5,404,244; 7,327,610; 7,593,154; and 8,482,837.

Thick film silver (Ag) paste is applied to create bus bars which traverse at least a portion of the device and terminate in solder tabs. The paste is dried and fired forming solderable bus bars. In some embodiments, the bus bars are fired at 380 to 420 deg. C.

In some embodiments, the bus bars can be on a single glass sheet, on a multilayer (2 or more) laminated structure, or part of an IGU. In some embodiments, a multiwire cable is attached to the IGU spacer, and individual wires are routed to the appropriate solder tabs. In some embodiments, a controlled amount of solder is affixed directly to each wire that will subsequently be soldered to a thick film Ag solder tab. In some embodiments, the wire is positioned on the solder tab and held in place by a clamp or other mechanism so that glass edges cannot be damaged and the extent of solder flow is controlled. In some embodiments, the soldered area is coated followed by application of secondary IGU seal. Finally, the thin film IGU is tested.

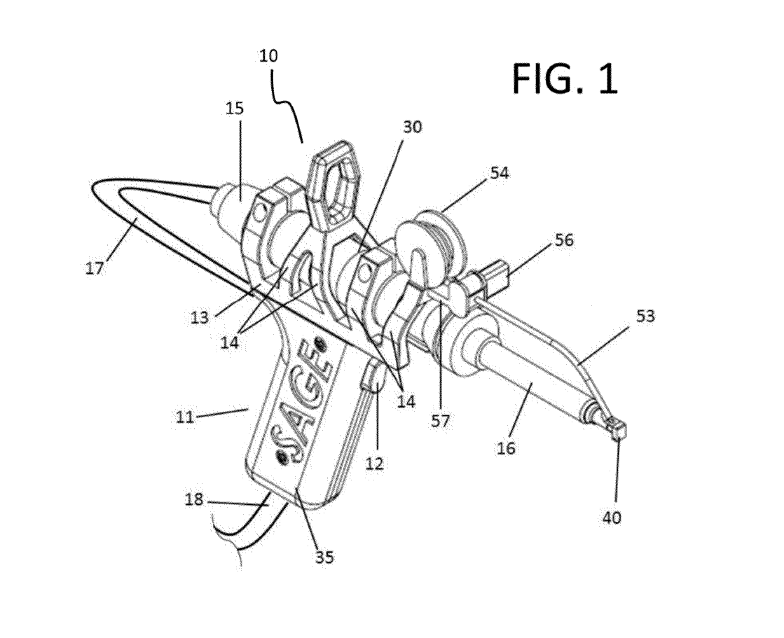

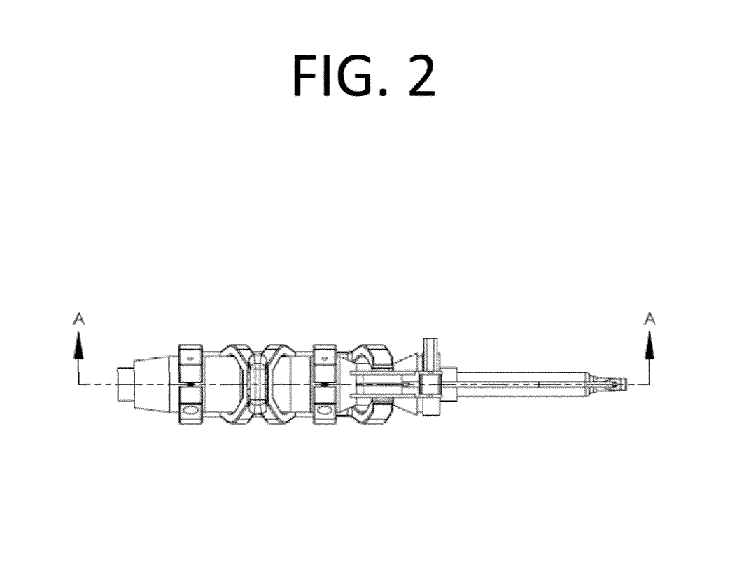

Referring now to FIG. 1, a soldering tool 10 in accordance with the current invention is shown. In some embodiments, the handle 11 of the soldering tool 10 is shaped to fit into the palm of an operator's hand. The handle 11 in the embodiment shown generally has the shape of a rectangle and is composed of two pieces that are substantially mirror images of each other. The pieces are mirrored at about line A-A as shown in FIG. 2. The pieces can be joined by screws, a press fit, glue, welding, or similar manner. In the embodiment shown, the assembled handle 11 is approximately 5 inches in length, 2 inches in width, and 1 inch deep. In some embodiments, the handle 11 is made of a lightweight material such as plastic, carbon fiber, Kevlar, resins, aluminum, or other composite materials.

The handle 11 has a trigger 12 for activating the power to the soldering element 30 in the front of the handle 11. In some embodiments the trigger 12 faces the same direction as the soldering tip 40 to provide comfortable operation of the soldering tool 10. The trigger 12 can be located at the top of the handle 11, adjacent to the platform 13, where a user's index finger is positioned when gripping the handle 11.

A platform 13 is connected to the top of the handle above the trigger 12 in the embodiment shown. In some embodiments the platform 13 can be a rectangular plank that is molded as part of the handle 11 to reduce manufacturing costs. In other embodiments, the platform 13 may be manufactured separately, then attached to the handle 11 by screwing, gluing, welding, or a similar method of securing two objects together, and depending, of course, on the materials used. The platform 13 can extend beyond the perimeter of the top of the handle 11 as necessary to provide an adequate base for the soldering element 30 to be secured to. The size of the platform 13 is therefore determined by the soldering element 30 to be used in the soldering tool 10. In some embodiments, the platform 13 is wider than the diameter of the outer casing 15 of the soldering element 30 to allow the ribs 14 to extend from the platform 13 and around the outer casing 15. In some embodiments, the platform 13 is at least as long as the segment of the outer casing 15 of the soldering element 30 that has a uniform thickness.

The soldering element 30 in the embodiment shown in [FIG. 1] is an ultrasonic soldering element, e.g. a MBR Electronics GmbH Ultrasonic Soldering System USS-9210. The soldering element 30 in this embodiment has a generally cylindrical outer casing 15. The outer casing 15 can be composed of plastic with low thermal conductivity, thereby remaining cool to the touch during operation of the soldering element 30. In the embodiment shown, a sleeve 16 extends from the outer casing 15 and the sleeve 16 contains the soldering tip 40. The sleeve 16 can be metal to withstand the heat generated by the heating apparatus (not shown) that is part of the soldering element 30. Power is supplied to the soldering element 30 by the wire running from the handle 11 to the back of the soldering element 30. The outer casing 15 of the soldering element 30 in the embodiment shown is approximately 10 inches long with a diameter of 2 inches. The sleeve 16 has a diameter of approximately 0.25-1 inch and extends beyond the front of the outer casing 15 by approximately 5.25 inches. The soldering element 30 is positioned on top of the platform 13 and is surrounded by ribs 14 extending from the platform 13, and up the sides of the soldering element 30. The ribs 14 themselves reach toward the medial line of the soldering tool (line A-A in FIG. 2). Thus, when the two halves of the handle 11 are joined the free ends of the ribs 14 contact, or nearly contact, the corresponding ribs 14 from the other half such that they can be secured to each other, thereby locking the soldering element 30 in place. In one embodiment, screws are used to secure the halves together. Alternative methods of attaching the halves of the ribs 14 together can be used including welding, gluing, press fits, and the like. The ribs 14 in the embodiment shown have a length of approximately 1.25 inches but can range from 1 inch to 4 inches depending on the thickness and orientation of the ribs 14. In some embodiments the ribs 14 are spaced approximately 0.75-1.5 inches apart from each other with approximately 1-2 inches of the soldering element 30 extending beyond the foremost and rear ribs 14. In other embodiments the soldering tool 10 may have only two ribs 14; one at the front and one at the back of the platform 13. The ribs 14 on each half of the solder tool can be parallel to the rib adjacent to it or, alternatively, some of the ribs 14 can converge to provide further stability. In some embodiments the ribs 14 may be replaced by a solid piece that engulfs the soldering element 30 when the two halves are joined.

In some embodiments, the ribs 14 can serve as a mounting apparatus for alternative features of the soldering tool 10. For example, a bracket 57 may be incorporated to support or act as a platform 13 to mount any additional interconnected elements in the design of the soldering tool 10 and molded as part of a rib. In one embodiment, additional interconnected elements can include a solder roll 54, precision roller drive gear motor 56, and solder feed tube 53 as shown in [FIG. 1].

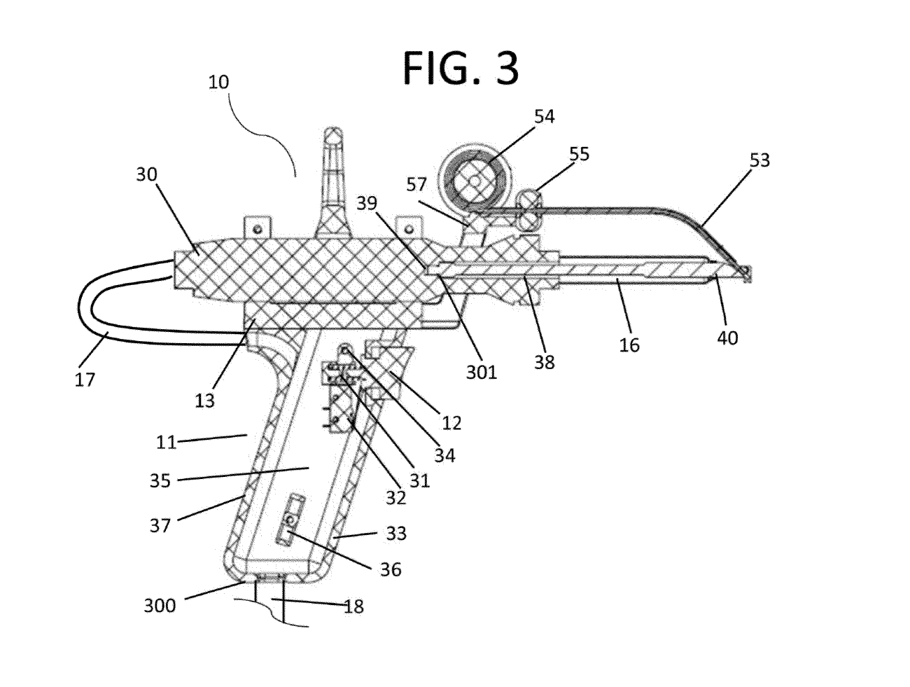

A cross sectional view of the soldering tool 10 can be seen in FIG. 3. The handle 11 may have walls 33, 37, 300, which define the cavity of the handle 11, extending perpendicularly from the plate 35 toward the medial line of the soldering tool 10. In some embodiments the front and back walls 35, 37 are substantially parallel to each other; and the bottom wall 300 is substantially parallel to the platform 13. In some embodiments each half of the handle 11, including the walls 33, 37, 300, platform 13, and ribs 14 are preferably formed as a solid piece through a molding process. In other embodiments the handle 11 can be made of separate pieces that compose one or more elements of the tool and then assembled through use of screws, welding, glue, or other appropriate means depending on the material used to manufacture the soldering tool 10. In some embodiments the cavity of the handle 11 may contain a weight to counterbalance the mass of the soldering element 30 and give the tool a more balanced feel.

In some embodiments the front 35 and back wall 37 have notches to allow power wires 17, 18 to enter and exit the cavity of the handle 11 for connecting the power supply (not shown) to the switch 32 and then to the soldering element 30.

In some embodiments the front wall 33 is shaped to allow the trigger 12 to move when pressed by an operator, thereby activating a momentary contact switch 32 to power the soldering element 30. In the embodiment shown in FIG. 3, a spring 34 is compressed against the trigger anchor 31 when the trigger 12 is squeezed, forcing the momentary switch 32 to complete the circuit and supply power to the soldering element 30. When the trigger 12 is released the spring 34 recoils pushing the trigger 12 to its original position, the circuit is broken, and the power to the soldering element 30 is turned off.

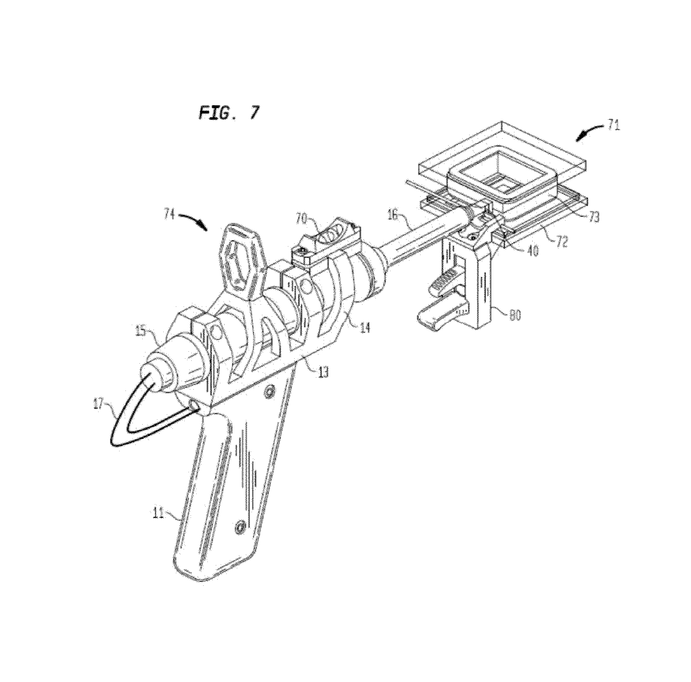

In other embodiments, the switch 32 is a low-amperage low-voltage contact switch that serves as an input to digital timer circuitry located in the power supply. In some embodiments, the digital timer circuitry activates power to the soldering element 30, turns on an LED (not shown) located on the under the bubble level 70 (see FIG. 7) and activates an audible signal generator that signifies to the operator that the soldering cycle is complete. In some embodiments, the power to the soldering element 30 is provided by the digital timer circuitry for approximately 4-6 seconds. The timer may then turn off the LED approximately 1-3 seconds after turning off the power to the soldering element. In some embodiments, the audible signal is active while power is being supplied to the LED and turns off simultaneously with the LED. These are indications to the operator that the soldering process is complete and the soldering tip may be removed from the soldering joint.

In other embodiments, different types of switches can be used with the same effect such as a pushbutton, toggle, rocker, slide, rotary switch, etc. The switch 32 must be sized to withstand the power requirements of the soldering element 30. Therefore, the soldering element selected will determine the switch that may be used. A soldering element that requires more power will require a switch that is able to withstand a higher power draw.

In the embodiment shown in FIG. 3, anchors 36 for the switch 32 and the trigger 12 are formed as part of the plate 35 in the cavity of the handle 11. The anchors 36 can be shaped to accommodate the switch 32 and the trigger 12. The anchors 36 may also be used to join the two halves of the handle 11 together. In some embodiments, the two halves are placed together whereby the anchors 36 align and a screw is inserted from the exterior of the handle 11 into both anchors 36, preventing the halves from separating. In other embodiments the anchors 36 could be adapted to fit together via a press fit, gluing, welding, or other appropriate method depending on the material used to manufacture the soldering tool 10.

In some embodiments, the handle 11 can have grip pads attached to the sides to increase the comfort of the operator during use.

In some embodiments, the platform 13 is adjacent to the front 33 and back 37 walls and is oriented substantially from the front to the back of the soldering tool 10. The platform 13 may provide a base to which the soldering element 30 is secured. The platform 13 can have a thickness from top to bottom ranging from about 0.25 to 2 inches. In the embodiment shown, the platform 13 has a thickness of about 0.3 to 0.75 inches. The platform 13 must be of sufficient thickness to withstand the weight of the soldering element 30 and the vibration generated during operation of the ultrasonic soldering tool 10.

In some embodiments, the outer casing 15 of the soldering element 30 is secured to the platform 13 by the ribs as shown in FIG. 1. In some embodiments the soldering element 30 is powered by a wire 17 that runs from the switch 32 in the cavity of the handle 11, through the notch in the back wall 37, and into the back of the soldering element 30. In other embodiments the wire 17 can be routed from the switch 32, through the platform 13, and into the side or bottom of the soldering element 30. The power supplied in the wire 17 is determined by the requirements of the soldering element 30. In some embodiments the power can range from 5-15 Watts for the ultrasonic requirements and 80 Watts for the heater apparatus.

In some embodiments, the ultrasonic vibration element, e.g. a sonotrode, is integrated in the outer casing 15. In some embodiments the sonotrode can align with the tip shaft 38, which may be co-axial with the sleeve 16. The tip shaft 38 can have a range of diameters from about 0.3 to 0.6 inches. In some embodiments, the sleeve 16 extends from the front of the outer casing 15 and may contain the heating apparatus, e.g. a ceramic heater (not shown). The tip can be inserted through the sleeve 16 and into the shaft 38 to use the soldering tool 10.

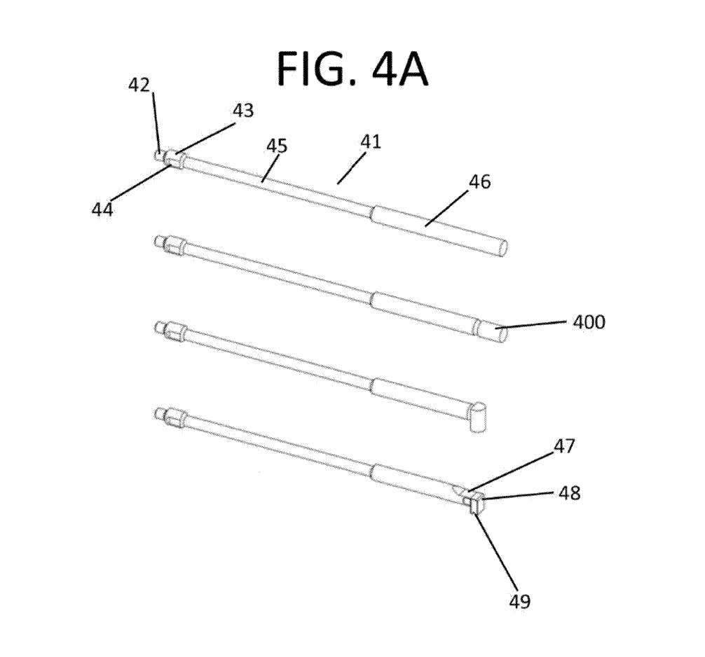

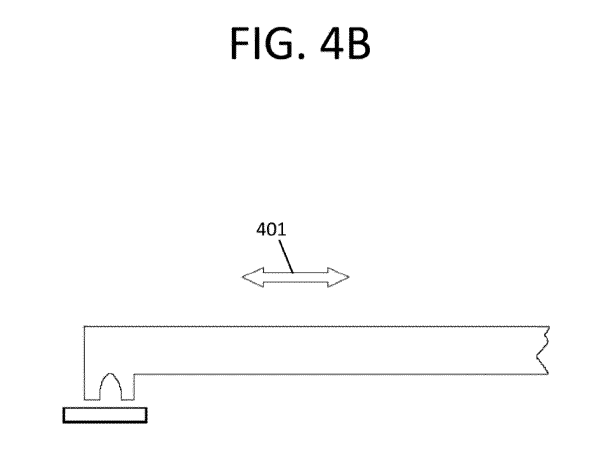

FIG. 4 shows a soldering tip 40 in accordance with the current invention. In some embodiments the tip can be manufactured from a stock blank tip 41 supplied by the manufacturer of the soldering element 30. In some embodiments the soldering tip 40 is composed of metal such as steel, iron, aluminum, or the like with a diameter of approximately 0.5 to 1 inch and a length of approximately 7.4 to 14 inches.

The soldering tip 40 has a tail 42 at its distal end which is sized to fit within the tip shaft 38 of the soldering element 30 (see FIG. 3). Those skilled in the art will appreciate that the tail 42 must be of sufficient diameter relative to the diameter of the tail shaft 39 to allow ultrasonic sound waves (not shown) to exert pressure on the tail 42 without significant blowby, but at the same time, not such a snug fit as to cause unnecessary friction between the walls of the tail shaft 39 and the tail 42. In some embodiments, the tail 42 has a diameter of approximately 0.3 to 0.6 inches and a length of approximately 0.15 to 0.5 inches with a face at the back end transverse to the front-back direction of the soldering tip 40. The sonotrode of the soldering element 30 emits high frequency sound waves which build up pressure against the face of the tail 42 and forces the soldering tip 40 to vibrate back and forth in the direction of oscillation 401 shown in FIG. 4B.

In some embodiments, the tail 42 is adjacent to the shoulder 43. The shoulder 43 may fit within the tip shaft 38 but may be wider than the tail shaft 39 (see FIG. 3). When the soldering tip 40 is vibrating back and forth the shoulder may contact the ledge 301 of the tail shaft 39 which prevents the tail 42 from contacting and damaging the sonotrode. In some embodiments, the shoulder 43 has an approximate diameter of 0.5 to 1 inch and an approximate length of 0.5 to 1 inches. The shoulder 43 may have retaining grooves 44 cut into its sides to secure the tip in place during operation which in some embodiments may be 0.15 to 0.35 inches long, 0.25 to 0.5 inches wide, and 0.05 to 0.2 inches deep.

In some embodiments of the soldering tip 40, the spacer 45 is proximal to the shoulder 43. The spacer 45 can have a diameter ranging from approximately 0.2 to 0.6 inches and a length of approximately 4 to 5.5 inches. The spacer 45 may be of sufficient length to ensure that the heat transferred to the soldering tip body 46 is not conducted from the body 46, through the spacer 45 and shoulder 43, and to the tail 42, thereby causing thermal expansion of the tail 42 and preventing its free movement.

In some embodiments, the tip body 46 is proximal to the spacer 45. The diameter of the body 46 can range from about 0.6 to 1 inches and the length can range from about 2 to 4 inches. The body 46 may be positioned substantially within the sleeve 16 of the soldering element 30 during operation of the soldering tool 10; with the front end of the body 46 protruding past the front of the sleeve 16 (see FIG. 1). In some embodiments, the body 46 is heated by the heating apparatus of the soldering element 30 located in the sleeve 16. The heating apparatus may be a ceramic heater that is constantly powered to maintain a constant temperature unlike the ultrasonic feature of the soldering tool 10 which is only powered when the trigger 12 is pressed by the operator.

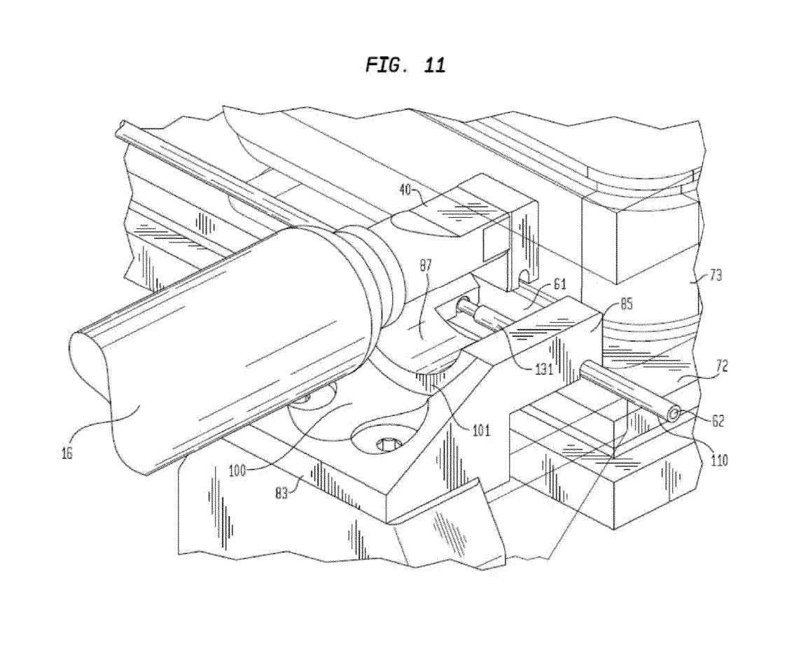

In some embodiments, the neck 47 is proximal to the body 46 and may have a smaller diameter than the body 46 such that the head 48 and neck 47 can fit in the narrow space between the layers of the IGU. In some embodiments, the height of the neck 47 can range from about 0.2 to 0.6 inches. The bottom of the neck 47 may remain parallel to the bottom of the body 46 to allow the operator to smoothly maneuver the tool back and forth while the bottom of the soldering tip 40 is in contact with the clamp 80 during operation. (see FIG. 11). The neck 47 can have a length ranging from about 0.75 to 3 inches.

In some embodiments, the head 48 is proximal to the neck 47 and is created by cutting off about 0.2 to 0.5 inches of the blank soldering tip, then undergoing connecting and machining operations as described below. In other embodiments, the head 48 may be manufactured distinctly from the rest of the tip and then attached to the neck 47 via a screw, welding, or other appropriate means depending on the material used to create the soldering tip 40. When a cut off portion 400 is used to create the head 48, it may be tooled to create a flat surface on one side to mate with the proximal end of the soldering tip 40 and secured into place via welding, screwing, gluing, or other appropriate means depending on the material used to create the soldering tip 40. In some embodiments, the cut off portion 400 may extend below the bottom of the neck 47 as shown in FIG. 4A.

In some embodiments, the cutoff portion 400 is then tooled to create a head 48 having a rectangular shape with dimensions ranging in size from about 0.01 to 0.3 inch wide by 0.2 to 0.5 inches long by 0.35 to 1.5 inches deep. In some embodiments, the neck 47 and head 48 are created during the same tooling process. In other embodiments, the head 48 and neck 47 are created by separate manufacturing processes and the head 48 is later secured to the soldering tip 40 by material appropriate methods.

In some embodiments, the face is located on the bottom of the head 48. In other embodiments, the face can be oriented at any angle on the soldering head 48.

In some embodiments, a trough 49 is located on the face. The trough 49 can extend from one side of the face to the other, thereby creating a horizontal trough 49. The horizontal orientation of the trough 49 can improve the ergonomic feel of the soldering tool 10. The downward orientation of the trough 49 allows the tip to be maneuvered at a low height above the solder joint such that the tip can fit in the narrow space between the layers of the IGU. The trough 49 allows the head 48 of the soldering tip 40 to surround the wire to be soldered, thereby creating a high quality solder joint as explained below. It is believed that the size of the trough 49 is influenced by the size of the wire to be soldered.

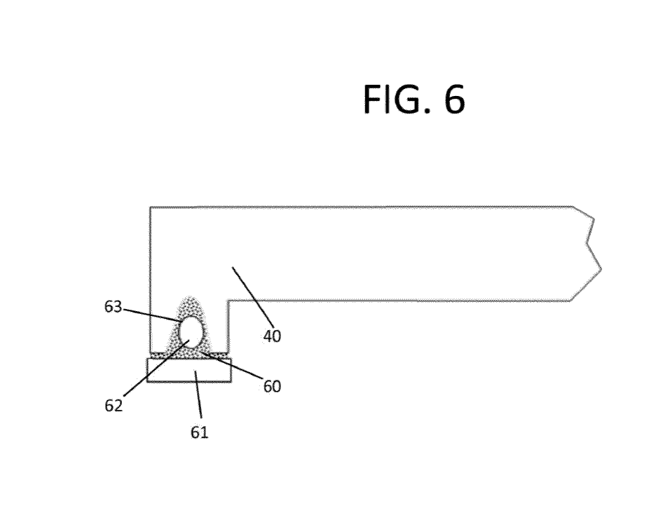

In some embodiments, the trough 49 can have a range of dimensions from about 0.1 to 1 inch long and 0.1 to 1 inch deep. In the embodiment shown in FIG. 4A, the trough 49 is approximately 0.05 inches long by 0.5 inches wide by 0.5 inches deep resulting in a trough 49 with a volume of approximately 0.0125 cubic inches. Although a range of values have been given for the head 48 and trough 49, it should be appreciated by those skilled in the art that the dimensions could be adjusted to accommodate wires of a larger or smaller diameter, or to create a solder joint that uses more or less solder. The trough 49 can be open on both sides and can have a parabola shape to produce fillet shaped edges of the solder joints 63 as shown in FIG. 6. In some embodiments, the shape of the trough 49 reduces the likelihood for the wire to be damaged by the soldering tip 40 during the soldering process because the trough 49 makes it unlikely that the soldering tip 40 will contact the wire.

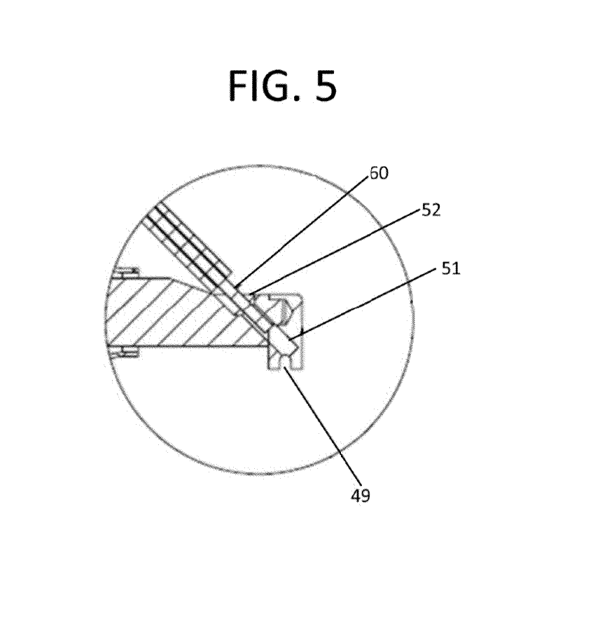

The trough 49 in the embodiment shown in FIG. 5 has been sized to create an ideal solder joint for a wire of a known thickness. In some situations, an ideal solder joint has smooth fillets on both sides of the wire having a radius approximately equal to that of the wire, with a smooth and shiny surface.

In other embodiments, an ideal solder joint is one with consistent fillets on the sides of the wire and also meets or exceeds the required pull strength testing of the joint. The application for which the IGU may be used can used to determine the pull strength needed. Some applications may require higher pull strength than others, e.g. high wind load environments. In some embodiments, a parallel pull test shows strengths of approximately 25N to 90N.

In some embodiments, it is desirable to create an ideal solder joint while using minimal solder which may be about 0.0001 to 0.0005 cubic inches of solder.

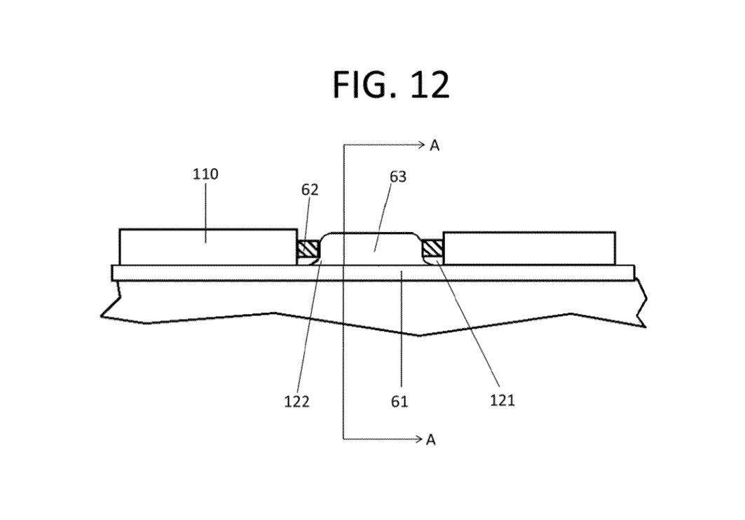

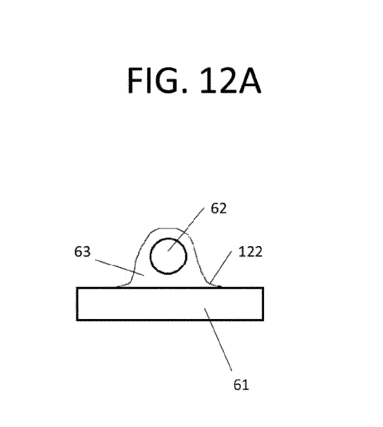

A larger trough will create a solder joint with higher pull strength but will require a greater volume of solder than is used in a smaller trough. A larger trough will also increase substrate heating during the soldering process because the soldering tip will need to remain in close proximity with the IGU for a longer period of time to melt the solder which could lead to damage as a result of thermal stress near the edge of the glass substrate. A smaller trough will reduce the necessary amount of solder but will reduce the pull strength of the solder joint. Reducing the amount of solder used can have significant economic benefits when an expensive solder (e.g. 97/3 Indium Silver) is used. An ideal solder joint allows the solder to completely surround the wire as shown in FIG. 6. The ideal solder joint 63 also has a fillet shape 122 (see FIG. 12) on the ends as well as the sides (see FIG. 12A) to reduce weak joints that are formed by perpendicular edges.

In one alternate embodiment, the neck 47 and head 48 have a solder feed port 51 extending from inside the trough 49, through the head 48, and emerging on the upper side of the neck 47 as shown in FIG. 5. In some embodiments, the solder feed port 51 can increase in diameter before it breaches the top of the neck 47 to create a solder well 52. Solder 60 can be placed into the solder well 52 where it is melted before it flows through the feed port 51 and into the trough 49. In some embodiments, the diameter of the feed port 51 can be sized to utilize capillary action as the mechanism to transport solder through the feed port 51 and into the trough 49. The size of the feed port 51 may range from about 0.01 to 0.05 inches in diameter and 0.1 to 0.5 inches in length. The solder well 52 can range from about 0.05 to 0.1 inches in diameter and 0.1 to 0.3 inches in length. The solder well 52 and the head 48 can be heated to approximately 230° C.+/−10° C. to melt the solder in the well 52. The temperature required to melt the solder is dependent on the type of solder used. In some embodiments, eutectic 97/3 Indium Silver solder, available from Indium Corporation of America, is used which has a melting point between about 140° and 150° F. The heat is supplied by the heating apparatus of the soldering element 30. The heat travels via thermal conduction through the soldering tip 40, heating the soldering well 52. In some embodiments, the solder 60 can be deposited in the solder well 52 from the solder feed tube 53 of the soldering tool 10.

One embodiment of the soldering tool 10 may include a bubble level 70 as shown in FIG. 7. The bubble level 70 may aid a user in properly orienting the alternate soldering tool during operation to prevent accidental contact with any surfaces of the IGU. The bubble level 70 in the embodiment shown is mounted to a surface formed by the ribs 14 of the alternate soldering tool 74. In some embodiments, the level can be permanently secured to the surface by screwing, gluing, or other appropriate ways. In other embodiments, the level 70 may be temporarily secured to the alternate soldering tool 74 to train the operator to properly use the soldering tool. When the operator is deemed to be of sufficient skill the bubble level 70 may be removed thereby reducing the weight and size of the alternate soldering tool 74 while at the same time improving the visibility of the soldering tip 40 during operation. In some embodiments, the level 70 is oriented from the front to the back of the alternate soldering tool 74 and is substantially parallel with the tip body 46 such that the bubble level 70 reflects the horizontal pitch of the tip body 46.

Returning now to FIG. 1, in some embodiments, a solder roll 54, solder drive rollers 55, precision roller drive gear motor 56, and solder feed tube 53 are combined with the soldering tool 10 of the present invention to create an automatic feed ultrasonic soldering tool. In some embodiments, using an automatic feed soldering tool can eliminate the step of pre-applying solder to a wire before soldering, thereby reducing the effort required to prepare the wire to be soldered.

In the embodiment shown in FIG. 1, a bracket 57 is created as part of the front rib 14 to accommodate a solder roll 54 and allow it to freely rotate when in operation. The same bracket 57 may be adapted to also support a precision roller drive gear motor 56 and solder feed tube 53. In some embodiments, the gear motor 56 turns rollers (see FIG. 3) which are positioned to tangentially pull the solder off the roll 54 and push the solder down the feed tube 53 to be delivered at the soldering head 48. The gear motor 56 may be activated by the same trigger 12 as that used to power the soldering element 30. The gear motor 56 can deliver a precise amount of solder to the soldering head 48 to ensure that no solder is wasted during the formation of each solder joint, thus resulting in the creation of a solder joint with minimal solder used. In some embodiments, the gear motor 56 is adjustable to allow an operator to supply more or less solder to the soldering head 48 each time the gear motor 56 is powered.

In some embodiments, the gear motor 56 may continuously supply solder to the soldering head 48 for the entire duration the trigger 12 is pressed. In other embodiments, the gear motor 56 may supply solder for a fixed period of time during each trigger 12 press, then refrain from providing solder while the soldering tip continues to form the solder joint and completes the soldering process.

In some embodiments, the bubble level is combined with the automatic feed soldering tool to allow the operator to observe the pitch of the soldering element while utilizing the benefits of the automatic feed soldering tool.

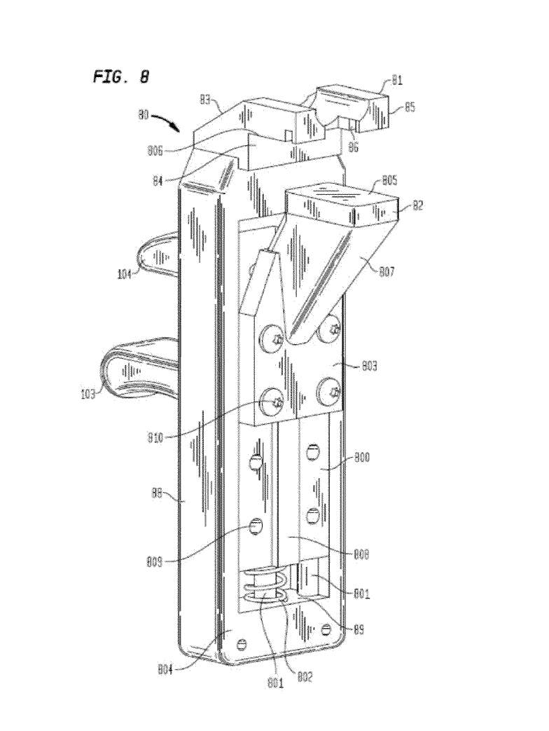

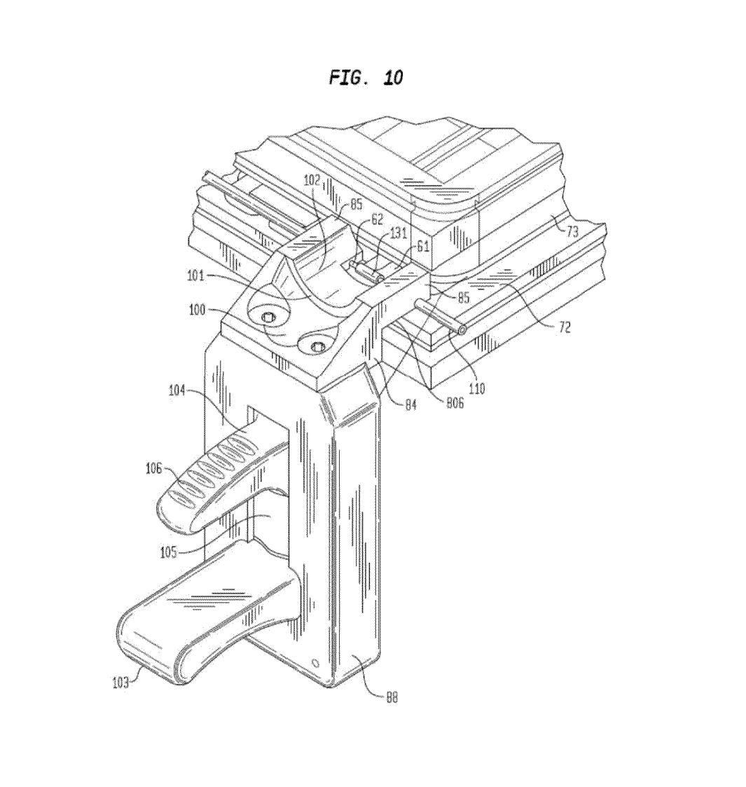

Turning now to FIG. 8, one embodiment of the clamp 80 in accordance with the current invention is shown. In some embodiments, the clamp 80 has an upper jaw 81 and a lower jaw 82. The upper jaw 81 can have an anchor 83 with two arms 85 extending from the elevated region of the anchor 83. The lower region of the anchor 83 below the arms 85 is the bumper 84. In some embodiments, the bumper 84 helps properly align the aperture 86 in the arms 85 with the wire and the solder tab 61 that the wire may be soldered to. The aperture 86 may be properly aligned when the arms 85 are inserted into the space between the layers of the IGU until the bumper 84 contacts the outer edge of the glass substrate 72 (see FIG. 10).

The anchor 83 can have a concave depression 100 on its upper surface to ensure proper clearance while operating the soldering tool. In some embodiments, the depression 100 may also be used to support and guide the sleeve 16 of the soldering tool 10 while in use. The radius of the concave depression 100 may be larger than the sleeve 16 radius of the soldering tool 10. In some embodiments the radius of the depression 100 can be about 0.25-0.5 inches. It is believed that in some embodiments, having a larger radius influences the soldering tool 10 to remain in the center of the anchor 83 during operation, but does not unnecessarily restrict it to a fixed spot. In some embodiments, the arms 85 remain connected by a membrane as they begin to extend away from the anchor 83 (see FIG. 10) which may have a valley 87 similar to the concave depression 100 of the anchor 83 and may support the soldering tip 40 during operation of the soldering tool 10. However, the valley 87 is elevated slightly above the depression 100 thereby creating a lip 101. In some embodiments, the lip 101 can prevent an operator from inserting the soldering tip 40 too deep into the IGU, thereby contacting and damaging the IGU spacer 73. As the soldering tip 40 moves along the valley 87 during the soldering process, the sleeve 16 of the soldering tool 10 may contact the lip 101, thereby preventing further insertion (see FIG. 11).

The arms 85 of the upper jaw 81 extend away from the anchor 83 with the bottom surface of the arms 85 able to contact the glass substrate 72 of the IGU 71. In some embodiments, the arms 85 can have a width of about 0.2 to 0.5 inches and a length of about 0.4 to 0.75 inches while the height of the arms 85 may be less than the size of the space between the layers of the IGU 71. In some embodiments, the height of the arms 85 may range from about 0.02 to about 0.075 inches. The arms 85 define a void between them where a wire may be located to be soldered. The underside 806 of the arms 85 may also have an aperture 86 for the wire that allows the bottom surface of the arms 85 to contact the IGU 71 while securing the wire to be soldered in place during operation. The depth and width of the aperture 86 are determined by the size of the wire to be soldered. In some embodiments, the depth and the width of the aperture 86 are equal and can range from about 0.02 to about 0.05 inches. The aperture 86 can be oriented horizontally to match the positioning of the wire on the IGU 71.

In some embodiments, the anchor 83 of the upper jaw 81 may be secured to the clamp housing 88 using screws, glue, welding, or other appropriate method based on the composition of the housing 88 and jaw 81. In some embodiments, the upper jaw 81 may be manufactured from a material that is temperature resistant, non-stick, and non-scratching, e.g. Rulon LR, a PTFE plastic produced by Saint-Gobain Performance Plastics. In other embodiments, the upper jaw 81 can be created as part of the clamp housing 88 and consist of the same material.

In some embodiments, the clamp housing 88 can have a substantially rectangular shape with dimensions ranging from about 0.3-0.6 inches deep by about 0.5-1 inch wide by about 2-4 inches high as shown in FIG. 8. In some embodiments, the top end of the housing 88 can be adapted to receive and secure the upper jaw 81. The housing 88 can have a central opening that defines a chamber 89 for the jaw sled 800, guide rods 801, and guide spring 802. In some embodiments, the chamber 89 does not extend all the way through the clamp housing 88. The chamber 89 can have sufficient depth to accommodate the other components of the clamp 80, but still have a substantially solid back portion to increase the overall strength and prevent distortion of the clamp 80 during operation. In some embodiments, the chamber 89 can have dimension ranging from about 0.2 to about 0.5 inches deep by about 0.25 to about 0.75 inches wide and about 1 to about 3 inches high.

In some embodiments, the chamber 89 may include one or more guide rods 801 that extend the length of the chamber 89 for the spring 802 and jaw sled 800. The guide rods 801 may be composed of steel, aluminum, or other similar rigid material. In some embodiments, at least one guide rod 801 is positioned toward the outside of the chamber 89 and at least one rod 801 is positioned toward the center of the chamber 89. The outer guide rod 801 can keep the sled 800 properly aligned as it moves up and down the chamber 89 during operation. The center guide rod 801 can keep the spring 802, as well as the sled 800, properly aligned. The spring 802 can exert a force on the bottom of the chamber 89 and the sled 800 to provide the compressive force necessary for the upper 81 and lower jaw 82 to press against the IGU 71 during operation and remain in place. In some embodiments the spring 802 can be compressed with a small enough force that an operator can attach and remove the clamp 80 from the IGU 71 with one hand e.g. about 3-5 lbs. of compressive force.

In some embodiments, the back of the clamp housing 88 can have a stub 103 extending away from the housing 88 as shown in FIG. 10. The stub 103 can have a concave underside shaped to accommodate an operator's finger when squeezing the clamp 80. In the embodiment shown in FIG. 10, the stub 103 is located below the slot 105 for the beam 104.

In some embodiments, the housing 88 can be manufactured substantially by a 3D printing process and require only minor secondary operations at assembly. One of the components that may need to be attached to the housing 88 during the secondary operations is the cover 804. The cover 804 can be attached to the front of the housing 88 and can secure the sled 800 and flange 803 inside the chamber 89. In some embodiments, the cover 804 can be press fit into place. In other embodiments, the cover 804 can be attached via screws, glue, welding, or other appropriate means depending on the material selected.

In some embodiments, the lower jaw 82 can have a top surface 805 that opposes the underside 806 of the arms 85. The top surface 805 may be substantially flat to maintain uniform contact with the IGU 71, thereby avoiding uneven pressure on the glass substrate 72. In some embodiments, the top surface 805 can have a rectangular shape with dimensions ranging from about 0.2 to about 0.5 inches wide by about 0.3 to about 0.75 inches deep.

The top surface 805 can be supported by the lower jaw base 807 which connects the top surface 805 with the jaw flange 803. In some embodiments, the lower jaw 82 can be manufactured using the same 3D printing process and material used to create the clamp housing 88. In other embodiments, the lower jaw 82 and flange 803 can be created from polymers, metals, or other solid materials. In the embodiment shown in FIG. 8, the flange 803 has screw holes 810 to attach the flange 803 to the sled 800. The flange can have a groove in the back side to mate with the sled tongue 808. In still other embodiments, the lower jaw 82 may have an additional protective material placed on its top surface 805 (e.g. rubber, silicone or similar) to prevent damage to the substrate 72 or accidental movement of the clamp 80 during operation. In some embodiments, the material may be a 1/16″ soft rubber pad attached with a pressure sensitive adhesive.

In some embodiments, the sled 800 is placed within the chamber 89 but remains free to move up and down the chamber 89. However, the spring 802 may exert a force to keep the sled 800 at the top of the chamber 89 when at rest. The shape of the sled 800 can follow the inner contours of the chamber 89 which in some embodiments is rectangular. The sled 800 can be shorter in length than the chamber 89 to allow the sled 800 to travel up and down during operation of the clamp 80. A shorter sled 800 in comparison to the chamber 89 can allow greater travel distance but may require a longer spring 802 to fill the void created by having a shorter sled 800. In some embodiments, the sled 800 may have cut outs to fit around the spring rod 801 and outer guide rods 801.

In some embodiments a beam 104 extends from the back of the sled 800 and through the slot 105 in the back of the housing 88 as shown in FIG. 10. In some embodiments, the top of the beam 104 may have relief cuts 106 to create friction between an operator's appendage and the beam 104 when in use. In other embodiments, other materials can be applied to the top of the beam 104 to improve the grip such as rubber or similar materials. In still other embodiments, the top of the beam 104 may have a plain, solid surface. The beam 104 can be fixed to the sled 800 such that if the beam 104 moves up and down the path defined by the slot 105, the sled 800 will move correspondingly. In some embodiments, the beam 104 can be aligned with the stub 103 and separated by a distance such that an operator can grip the stub 103 with a finger and the top of the beam 104 with the thumb of the same hand and squeeze the two together, thereby separating the upper 81 and lower 82 jaws to apply and remove the clamp 80 from the IGU 71.

The front of the sled 800 is substantially flat with a tongue 808 extending forward that runs the length of the sled 800 from top to bottom which may assist in properly aligning the groove of the flange 803 on the sled 800. In some embodiments, the front of the sled 800 can have various screw holes 809 for connecting the flange 803 to the sled 800 in more than one position, thus making the clamp 80 adjustable.

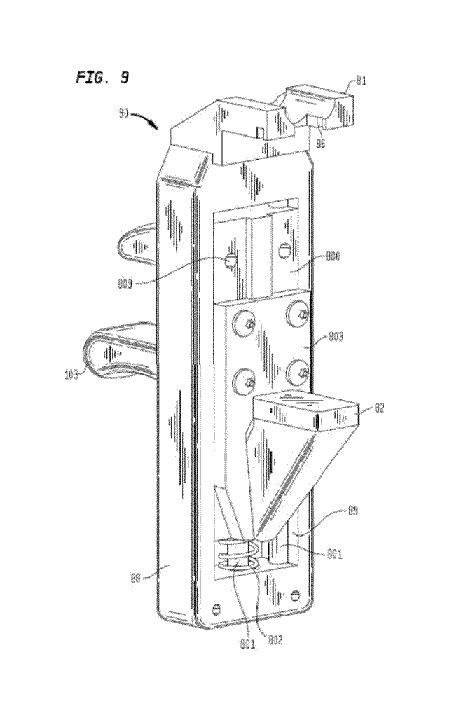

FIG. 9 shows a wide opening clamp 90 that is adapted to be used with thick laminates or triple pane IGU configurations. The embodiment shown depicts screw holes 809 that allow discrete changes in the alignment of the flange 803 on the sled 800. It should be understood that the screw holes 809 shown are merely exemplary and a greater or lesser quantity of holes could be included to increase or decrease the different locations the flange 803 can be positioned at. In other embodiments of the adjustable clamp 90, the flange 803 can be secured in any position along the sled 800 and need not align with specific locations.

As discussed previously, the ideal solder joint is one that achieves or surpasses the required pull strength while using minimal solder. In some embodiments, it is desirable to have a solder joint 63 where the solder 60 completely surrounds the wire 62 (see FIG. 6). This may not happen if the wire 62 is in contact with the solder tab 61. Therefore, in some embodiments it is desirable for the wire 62 to remain separated from the solder tab 61 during soldering. The size of the gap between the wire 62 and solder tab 61 which may be filled by solder 60 is determined based on the size of the wire 62 and the pull strength desired from the solder joint 63 with a larger joint 63 resulting in higher pull strength.

In some embodiments, to maintain the spacing 121 between the wire 62 and the solder tab 61, the wire insulation 110 functions as a spacer as shown in FIG. 12. Prior to soldering, the insulation 110 is peeled back or removed to expose a length of the wire 62 where it will be soldered (see FIG. 11) which in some embodiments can range from about 0.05 to 0.3 inches. Exposing the wire 62 can be done before the soldering process begins which may save time during the soldering operation. In some embodiments, the insulation 110 thickness can range from about 0.005 to 0.025 inches. In some embodiments, the wire insulation 110 can be used as the spacer during soldering in combination with the automatic feed soldering tool described above.

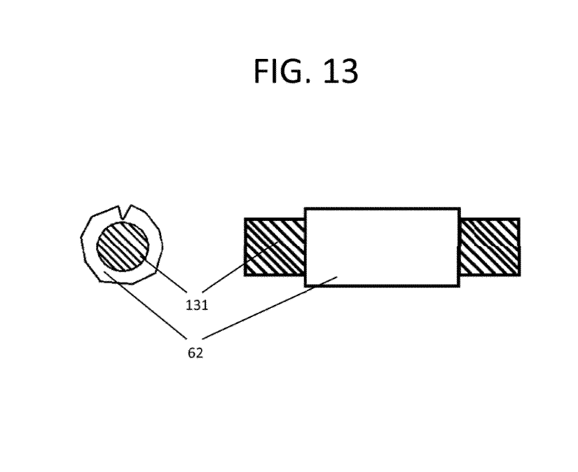

In other embodiments, solder 60 may be pre-applied to the exposed wire 62 to prevent the wire from contacting the solder tab 61 during soldering, as shown in FIG. 13. Pre-applying solder to the wire may have the additional benefit of supplying a precise amount of solder for each solder joint. In addition it is believed that pre-applied solder may result in a defined final position of the wire once the solder joint has been created, thereby resulting in consistent pull off strength of the joint.

In some embodiments, a solder ribbon 131, ranging from about 0.1 to 0.25 inches wide, is swaged or crimped around the exposed wire. In other embodiments, the solder is cast around the wire. In some embodiments, the radius of the outside of the solder ribbon 131 is equal to the outside radius of the wire insulation 110 such that the solder 131 is tangential to the solder tab 61 when the wire 62 is placed on the glass substrate 72 of the IGU 71.

In some embodiments, a wire with solder ribbon 131 can be soldered to the solder tab 61 by utilizing the soldering tip 40 with a trough 49 of the current invention. The trough 49 can surround the solder ribbon 131, thereby melting the solder and forming the solder joint 63 in a parabola shape, which may be desirable in some embodiments.

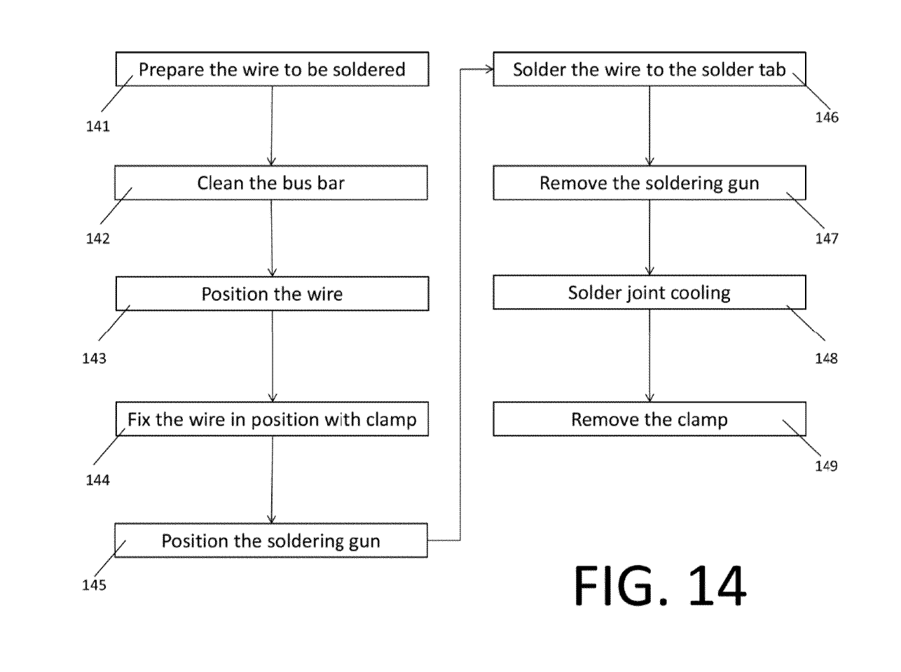

FIG. 14 is a flow chart depicting a method of the soldering process in accordance with one embodiment of the present invention. In some embodiments, the process begins in step one 141 wherein a wire is prepared to be soldered. The preparation may include separating or removing the insulation from the wire in predefined locations such that the exposed portions of wire align with the solder tabs of the IGU.

In some embodiments, step two 142 is commenced by cleaning the solder tab 61 with a fiber glass pen which may remove the oxidized top layer off the silver solder tab 61 by a controlled abrasive action. In other embodiments, a fine-wire stainless steel brush may be used.

In some embodiments, the step three 143 is positioning the prepared wire on the solder tab 61. In some embodiments, the operator may manually hold the wire in place until step four 144 is completed.

In some embodiments, step four 144 entails fixing the wire in position on the solder tab 61 using the clamp 80 of the current invention. In some embodiments, the operator may hold the wire 62 in place with one hand while operating the clamp 80 with the other hand. The jaws 81, 82 of the clamp 80 may be opened by the operator and the bumper 84 may be placed in contact with the outer edge of the glass substrate 72 of the IGU 71. The operator may then adjust the clamp 80 such that the arms 85 of the clamp 80 surround the exposed wire 62 to be soldered, ensuring that the wire 62 is aligned with the aperture 86 of the arms 85, then release the beam 104 and stub 103, thereby allowing the jaws 81, 82 of the clamp 80 to close, fixing the wire 62 in place.

In some embodiments, step five 145 is the positioning the soldering tool 10 so the neck 47 of the soldering tip 40 contacts the valley 87 of the clamp 80 to maintain the lateral positioning of the soldering tool 10 during soldering. In some embodiments, the operator may visually confirm that the trough 49 of the soldering tip 40 is aligned with the wire 62, then place the tip 40 in position such that the trough 49 is surrounding the wire 62 to be soldered.

In some embodiments, step six 146 may be when the operator activates power to the soldering tool 10, thereby ultrasonically soldering the wire 62 to the solder tab 61. In some embodiments, the operator may visually inspect the solder joint 63 as it is being formed. The operator may then deactivate the power to the soldering tool 10 after the joint is formed. In some embodiments, the power is supplied to the soldering tip for 4-6 seconds to create the solder joint.

In some embodiments, the operator may need to manually apply solder at the solder joint location to create the solder joint. In other embodiments, such as when the automatic soldering tool is used, the solder may be supplied by the soldering tool, thus relieving the operator of the duty to manually supply solder at the solder joint location.

In some embodiments, step seven 147 may be when the operator removes the soldering tool 10 from the soldering location by raising the soldering tip 40 until the trough 49 no longer surrounds the solder joint 63. The operator may then move the soldering tool 10 away from the IGU 71.

In some embodiments, the solder joint may freeze during step eight 148 which occurs when the operator removes the soldering tool 10 and puts the tool aside. In some embodiments, the joint may freeze in about 2-3 seconds.

Step nine 149, in some embodiments, may be when the operator removes the clamp 80 from the IGU 71. The operator may grip the beam 104 and the stub 103 and squeeze them together, thereby opening the jaws 81, 82 so the clamp 80 may be removed.

In some embodiments, the process described in FIG. 14 may be repeated as many times as necessary to solder any number of joints desired on an IGU.

1. A soldering tool comprising:
a handle;
an ultrasonic soldering element adapted to receive a soldering tip;
wherein said soldering tip is adapted to operate between parallel substrates of an insulated glass unit; and
at least one rib extending from said handle to secure said soldering element to said handle.

2. The soldering tool of claim 1, further comprising a soldering tip head having a trough.

3. The soldering tool of claim 1, further comprising a trigger to activate power to said soldering element.

4. The soldering tool of claim 3, wherein said trigger activates power to said soldering element by sending a signal to digital timer circuitry.

5. The soldering tool of claim 4, wherein said digital timer circuitry includes a switch for activating power to the ultrasonic soldering element.

6. The soldering tool of claim 4, wherein said digital timer circuitry powers an indicator LED on said soldering tool.

7. The soldering tool of claim 4, wherein said digital timer circuitry activates an audible signal generator when the soldering cycle is complete.

8. The soldering tool of claim 1, wherein said rib is further adapted for mounting one or more interconnected elements to said rib.

9. The soldering tool of claim 8, wherein at least one of said interconnected elements is a bubble level oriented substantially parallel to said soldering head.

10. The soldering tool of claim 8, wherein at least one of said interconnected elements is a solder roll mounted to said rib.

11. The soldering tool of claim 10, further comprising drive rollers mounted to said solder roll, wherein said drive rollers are adapted to transfer solder from the solder roll.

12. The soldering tool of claim 11, further comprising a gear motor mounted to said drive rollers and adapted to rotate said drive rollers.

13. The soldering tool of claim 12, further comprising a solder feed tube mounted to said drive rollers adapted to guide solder from said solder rollers to said soldering tip head.

14. The soldering tool of claim 12, wherein said gear motor rotates said drive rollers to provide a fixed volume of solder to said soldering head.

15. The soldering tool of claim 12, wherein said gear motor is adjustable to modify said volume of solder provided by said drive rollers.

16. The soldering tool of claim 13, wherein said soldering tip head has a trough and a solder feed port extending from an exterior surface of the tip into said trough.

17. The soldering tool of claim 16, wherein said solder feed port is adapted to transport solder from said solder feed tube into said trough.

18. The soldering tool of claim 17, further comprising a solder well between said solder feed tube and said solder feed port; said solder well adapted to receive and melt solder from said solder feed tube.

19. A soldering tip comprising an elongated member having a head with a trough adapted to surround a wire during soldering.

20. The soldering tip of claim 19, wherein said trough is oriented substantially horizontally to said soldering element.

21. The soldering tip of claim 19, wherein said trough has a parabolic profile.

22. The soldering tip of claim 19, wherein said head has a solder feed port extending from an exterior surface into said trough.

23. The soldering tip of claim 22, wherein said solder feed port is sized to transport solder via capillary action.

24. The soldering tip of claim 22, further comprising a solder well adapted to melt solder connected to said solder feed port.

25. A clamp comprising:
a housing having a chamber;
a sled within said chamber, wherein said sled is free to move within said chamber in at least one dimension;
an upper jaw connected to said housing;
a lower jaw connected to said sled; and
a spring within said chamber exerting a force against said sled and said housing to maintain said upper jaw and said lower jaw in close proximity to each other.

26. The clamp of claim 25, further comprising a stub extending from said housing and a beam extending from said sled;
wherein said beam is free to move along a path defined by a slot in said housing; and wherein
said beam and said stub extend in similar directions such that an operator may adjust the position of said beam relative to said stub with one hand, thereby changing the proximity of said upper jaw and lower jaw.

27. The clamp of claim 25, further comprising a protective material attached to said lower jaw.

28. A method of ultrasonically soldering a wire to a solder tab comprising preparing a wire to be soldered; cleaning said solder tab; positioning said wire on said solder tab; fixing said wire in position with a clamp; positioning a soldering tool to solder said wire; ultrasonically soldering said wire to said solder tab; wherein a solder joint is formed in a space between the layers of an insulated glazing unit.

29. The method of claim 28, further comprising delivering a precise volume of solder to said solder joint, thereby creating a solder joint having a desired pull strength using minimal solder.

30. The method of claim 28, wherein solder is pre-applied to said wire before positioning said wire.

31. The method of claim 28, wherein solder is supplied to said wire by an automatic feed soldering tool.

32. The method of claim 28, further comprising controlling the volume of solder supplied to said solder joint and the duration of contact between said soldering tool and said wire.
